(19) United States
(12) Patent Application Publication
(10) Pub. No.: US 2020/0139555 A1
(43) Pub. Date: May 7, 2020

(54) Apparatus for Cleaning Industrial Plants

(71) Applicant: PNP DISCOVER SRL, LUCCA (IT)

(72) Inventor: Alessandro Paterni, CAPANNORI (IT)

(21) Appl. No.: 16/620,149

(22) PCT Filed: Jun. 6, 2018
(86) PCT No.: PCT/IB18/54040

§ 371 Date: Dec. 6, 2019

(30) Foreign Application Priority Data
Jun. 6, 2017 (IT) 102017000061495

(51) Int. Cl. B25J 11/00; B08B 5/04; B25J 15/00; B25J 9/16; B25J 19/04; B25J 13/08; B08B 5/02

(52) U.S. Cl. CPC B25J 11/0085; B08B 5/04; B25J 15/0019; B08B 5/02; B25J 19/04; B25J 13/085; B25J 13/087; B25J 9/1679

(57) ABSTRACT

An apparatus (1) for cleaning industrial plants comprises a robotic arm to a working head of which are associated suction members suitable for sucking powders and working fragments inside a working volume in which a processing industrial plant is installed (L). The working head comprises an extensible manifold for moving the suction mouth (40) away from the end of the robotic arm thus allowing to reach remote positions and moreover the robotic arm (10) is mounted on moving members, for example a portal, which allow the robotic arm to be moved at different useful working volumes so that an accurate cleaning can be performed on a very large overall volume.

### TECHNICAL FIELD

The present invention relates to an apparatus and a method for cleaning industrial plants in which it is processed or transformed a material which, during processing or transformation, produces powders as a residue of the process.

In a specific embodiment, the invention relates to an apparatus for cleaning plants for converting paper.

### STATE OF THE ART

Many industrial machinery and plants, such as machine tools for metal, wood or plastic chip removal, as well as paper processing plants, during their operation generate waste or powders of various grain size spreading in the air and then settling on the machines themselves and in the other surrounding structures and equipments, causing inefficiencies of the machinery and production stops for carrying out cleaning operations.

The known art of the sector comprises various methods and apparatuses for cleaning by suction, for example in the field of wood processing, the powders and scraps are removed from the processing area by means of impellers and pushed towards extraction hoods placed above the machines and connected with vacuum pump lines. These systems are very cumbersome because they involve the presence of large volumes for the passage of air and the use of considerable suction power with a lot of air flow so that they could create a force sufficient to move the powders suspended in the air. This obviously also involves a large electrical power need to supply the aforementioned suction systems, which translates into a high energy expenditure and therefore a high cost.

Moreover, all the surfaces of the extractor hood, both internal and external, and all external surfaces of the pipes, are in time intended to accumulate other dust which remains in the air and therefore other manual operations are necessary for maintaining the cleaning of the plant itself.

They are also known systems which provide for the installation of suction mouths directly in the areas where the material is processed, in this case the power of the vacuum pumps can be reduced, but the presence of the suction system in the proximity of the processing area disadvantageously makes the machine inaccessible.

In general, all conventional cleaning systems have a limited efficiency and the machines need to be cleaned on all neighboring surfaces therefore this operation is manually performed. For example, in metal processing by milling and turning operations, the processing chips are deposited around the machine and the cleaning operations are generally carried out first blowing compressed air, then removing by manual suction or brushing operations and collection through paddles.

In the paper processing sector as well, especially in the tissue paper, for the production of toilet paper rolls and towels, suction systems are required. In fact, the paper fibers are detached from the tape and deposited everywhere creating a cluster that negatively affect the quality and efficiency of the process. These cluster of paper dust are mainly to be eliminated in order to reduce the risk of fire and for this reason expensive and complex dust extraction systems are necessary on the paper processing lines. These systems are generally made up of vacuum pumps, which create an air depression in order to suck through boxes with suction mouths, which develop along the entire length of the tape, and which are placed in the areas where the powder is most produced. All the boxes inserted in the line create accessibility problems both for the use and for the maintenance of the machines themselves, often they are made with systems that allow them to be moved by sliding on guides with manual or automatic actuators, but the plants end up being increasingly complex and the spaces for using the machine are still sacrificed. Moreover, the dust can not be captured in its entirety as the paper itself, which is the vehicle, passes through all the devices of the processing line, distributing both inside and outside the machines and on the floorings. In general, many manual cleaning operations remain necessary. These create safety problems for the operators, since they have the risk of breathing those suspended airborne dust, which increase during the cleaning phase itself. Even during the dirt removal phase, there is the risk of being hit by a reaction to the pushing force they exert, for example by acting with compressed air on the dirt itself.

Still, in plants where paper is transformed there is the problem of dust deposited on all the air structures such as pipes and structural beams, which represents a real problem in case of fire. Normally once a week the production plant stops to provide for blowing and removing this dust. This operation has several drawbacks such as the temporary pollution of the air, which is harmful to the operators, and the subsequent deposition of all the dust on the surfaces on the ground, which must then be removed.

To remove the dust from paper processing machinery, multi-articulated arm devices are known which on the end are provided of a working head capable of cleaning the machinery.

The document DE 102 52 812 A1 describes a unit for cleaning paper processing machinery which is movable in a working volume by means of a multi-articulated arm. The cleaning unit can work by suction or by blowing and can include collision temperature sensors or others. The multi-articulated arm on which the cleaning head is mounted is appropriately installed on a sliding carriage along a track in order to increase its working volume, moreover the cleaning device can operate through a purely software offline programming, or via any kind of learning programming.

The aforementioned document understands the potential benefits of providing, for cleaning paper processing plants, cleaning units mounted on multi-articulated robotic arms, however it is able to suggest a purely conceptual solution, without proposing solutions to the real problems related to an application of this type and related in particular to the need to reach parts of the machinery difficult to reach, to cover the largest possible working volumes without creating an obstacle to the processings, to contain the production costs of the cleaning device itself and of the auxiliary plants, primarily the air intake system.

### SUMMARY OF THE INVENTION

The main object of the present invention is therefore to propose a robotized apparatus for cleaning industrial plants capable of eliminating, or at least greatly reducing, the aforementioned drawbacks.

Another object of the present invention is to propose a robotized apparatus for cleaning industrial plants capable of performing an accurate cleaning of the entire installation volume of the industrial plant.

Another object of the present invention is to propose a robotized apparatus for cleaning industrial plants which does not require high power suction means.

Another object of the present invention is to propose a robotized apparatus for cleaning industrial plants that does not impede access to the machinery of the plant itself.

Another object of the present invention is to propose a robotized apparatus capable of carrying out the cleaning during the production itself, thus increasing the efficiency of the system.

These and other objects are obtained by means of an apparatus for cleaning industrial plants of the type comprising suction members suitable for sucking powders and working fragments within a working volume in which an industrial processing plant is installed. The apparatus for cleaning of the present invention is characterized in that it comprises:
at least one anthropomorphic robotic arm with at least three controlled axes, preferably three rotational joints, provided with a working head (14) which actuates the displacement of a manifold (15) on which an intake mouth is installed, connected by said manifold and by a suction line to vacuum creating organs;
movement members with programmable movements adapted to move said at least one robotic arm in correspondence of different useful working volumes;
   and wherein said at least one robotic arm is controlled by a self-learning control unit.

Advantageously, the manifold is inserted in a sleeve so as to be able to slide and extend with respect to the last joint of the robotic arm so as to be able to reach farther parts but above all insert itself for cleaning between the machine and the floor where the dust settles.

Advantageously, the programmable movement members comprise an oscillation assembly for each robotic arm and said oscillation assembly which comprise an elongated element which supports at one end said robotic arm while at the other end it is integral with a fulcrum assembly associated with a structure and arranged to rotate said elongated element with respect to at least one vertical axis and one horizontal axis transverse to the direction of advancement of said line.

Still advantageously, at least one vision sensor, at least one temperature sensor and at least one force sensor are associated with the working head.

Still advantageously with the suction duct is associated at least one vacuum level sensor and with said working head there is associated at least a first nozzle for blowing compressed air, suitable for automatically blowing compressed air through said suction mouth following the detection of certain variations in the vacuum level by said vacuum level sensor.

Still advantageously with said working head is associated at least one further nozzle for blowing compressed air arranged to blow compressed air towards the surfaces to be cleaned.

### BRIEF DESCRIPTION OF THE DRAWINGS

These and further advantages and characteristics of the present invention will be better understood by any person skilled in the art from the following description and with the aid of the attached drawings, provided as an example, but not to be considered in a limiting sense, in which:

FIG. 1 is a schematic perspective view of a tissue transformation line for obtaining toilet paper or towel, in which a cleaning apparatus according to the present invention is installed;

FIG. 2 shows a side view of a suction assembly forming part of the cleaning apparatus of FIG. 1 comprising a robotized arm with three controlled axes and a corresponding oscillation members;

FIG. 3 shows the suction assembly of FIG. 2 in a perspective view from below;

FIG. 4 shows a top view of a suction head of the suction assembly of FIG. 2;

FIG. 5 illustrates a sectional view of the suction head according to the section line A-A of FIG. 4;

FIG. 6 shows a store for suction mouths of the apparatus of FIG. 1: FIG. 6A shows the store with the suction mouths inserted, FIG. 6B shows the store without suction mouths;

FIG. 7 shows a perspective view of a variant embodiment of a robotic arm in an apparatus according to the invention with an extensible suction manifold: FIG. 7A shows the intake manifold in retracted configuration, FIG. 7B shows the intake manifold in extracted configuration;

FIG. 8 shows a schematic top view of the embodiment of FIG. 7 in a working configuration in which the working manifold is extracted;

FIG. 9 shows, in a view similar to that of FIG. 1, a tissue transformation line in which a different embodiment of a cleaning apparatus according to the present invention is installed;

FIG. 10 shows a front perspective view of the suction assembly of FIG. 2;

FIG. 11 shows a detail of FIG. 7;

FIG. 12 shows a variant of the embodiment of FIG. 7;

FIG. 13 shows a further variant of the embodiment of FIG. 7.

### DESCRIPTION OF THE PREFERRED EMBODIMENTS

With reference to the aforementioned figures, it is below described an exemplary embodiment of an apparatus for cleaning industrial plants according to the present invention, installed in a line for converting tissue to obtain toilet paper or towels.

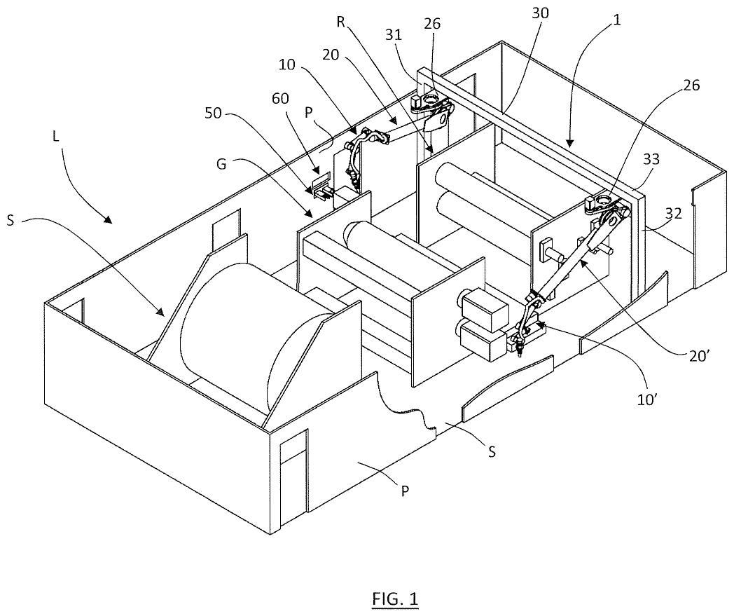

With reference to FIG. 1, a line for converting tissue, L, includes, for example, an unwinding device, S, for unwinding mother coils, an embossing machine, G, for obtaining reliefs by pressing between rollers, a rewinding boring machine, R, for making transversal perforations for obtaining the splits and for the rewinding process in diameters for the finished product, and an apparatus for cleaning, 1, according to the present invention, comprising two robotic arms, 10, 10′, and related moving elements consisting of oscillation assemblies, 20, 20′.

The portal 30 comprises two uprights, 31, 32, aligned transversely to the sides of the line L which support a crosspiece 33, which joins them transversely crossing the line L above the relative machinery. The uprights 31, 32 are connected to a floor, S, and/or walls, P, of the room in which the line L is installed, so as to be movable in the longitudinal direction of the line L itself. Advantageously, the portal 30 slides on rails integral with the ground S or with the walls P according to modes not shown in the figure because of known art. The movement of the portal 30 is motorized, for example by means of rack transmission means, not shown because of known art.

In the vicinity of each upright, 31, 32, it is bonded to the cross member 33 an oscillation assembly 20, 20′, each of which supports a relative robotic arm 10, 10′. In this way, the portal 30 is suitable for moving the oscillation assemblies 20, 20′ with respect to the L line of industrial machinery to allow the relative robotic arm 10, 10′ to reach all the areas to be cleaned of the line machinery.

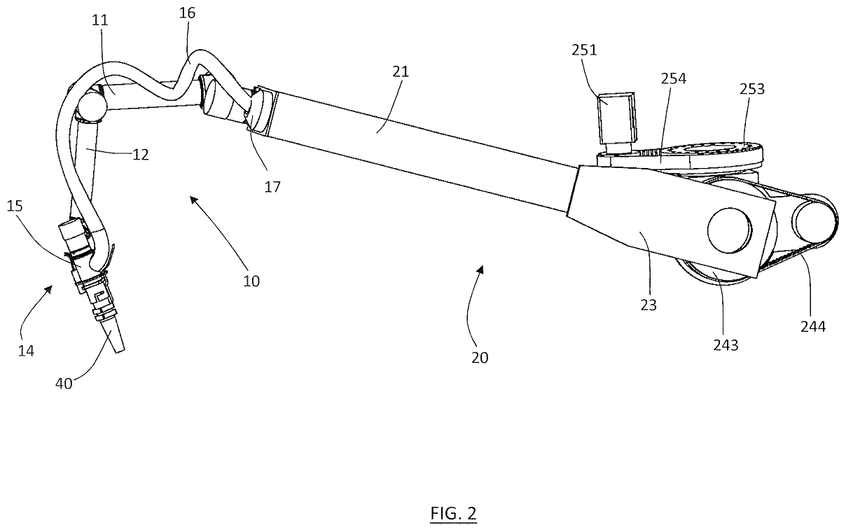

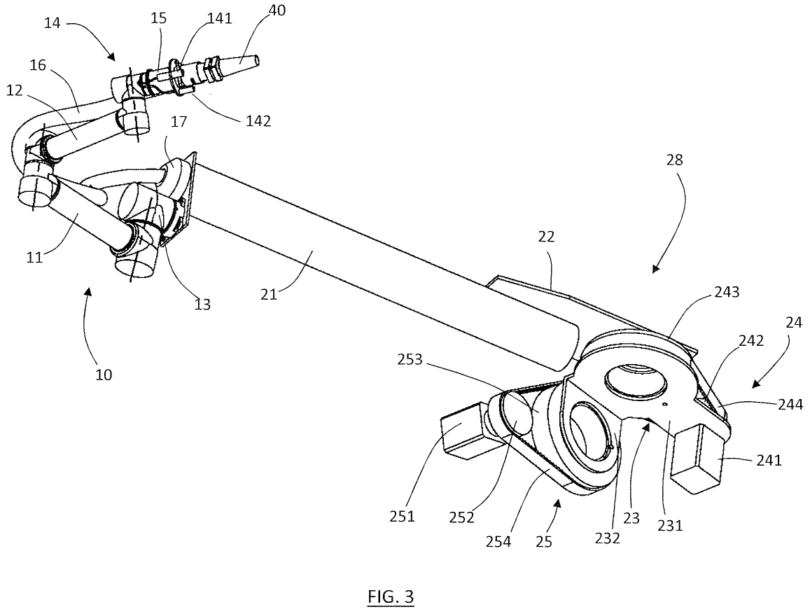

With reference to FIGS. 2 and 3, a robotic arm 10 has three controlled axes, in particular three rotational joints, and therefore comprises two elongated elements 11, 12, connected to each other jointly and connected to the respective free ends, by means of further joints, to a fastening element, 13, on one side, and to a working head, 14, on the other. The working head 14 comprises a manifold, 15, from which a flexible pipe 16 emerges, connected at some points to the elongated elements 11, 12 of the robotic arm 10 so that it can accept the various positions assumed by the arm itself.

The fastening element 13 is integral with the free end of an elongated tubular element 21 of the oscillation assembly 20. At the same end of the elongated tubular element 21 the flexible pipe 16 is connected by means of a manifold, 17. At the other end thereof the elongated tubular element 21 is connected by means of a bracket 22 to a fulcrum assembly 28 which allows rotation with respect to the crosspiece 33 according to two axes orthogonal to each other. More precisely, the fulcrum assembly 28 comprises an angular bracket, 23, adapted to support first rotation means, 24, and second rotation means, 25, both of the belt type and arranged to transmit the rotary motion with respect to two rotational axes orthogonal to each other. The first rotation means comprise: a motor, 241, integral with the angular bracket 23; a first driving wheel, 242, driven by the motor 241 and having an axis perpendicular to that of a first plane, 231, of the angular bracket 23; a first driven wheel 243, integral with the bracket 22 and rotatably mounted on the angular bracket 23 to rotate with respect to a rotation axis parallel to that of the first driving wheel 242; a first drive belt 244 for transferring the motion from the first driving wheel 242 to the first driven wheel 243. The second transmission means 25 comprise: a motor, 251, integral with an anchoring bracket, 26, for anchoring the oscillation assembly 20 to the crosspiece 33 (visible in FIG. 1 but not shown in FIGS. 2 and 3); a second driving wheel, 252, driven by the motor 251 and having an axis perpendicular to that of a second plane, 232, of the angular bracket 23 orthogonal to the first plane 231; a second driven wheel 253, integral with the angular bracket 23 and pivotally mounted on the anchoring bracket 26 to rotate with respect to a rotation axis parallel to that of the second driving wheel 252; a second drive belt 254 for transferring the motion from the second driving wheel 252 to the second driven wheel 253. The configuration of the oscillation assembly 20 and the arrangements for constraining the portal 30 are such as to provide a vertical rotation axis and a horizontal rotation axis, transverse to the line L, of the elongated tubular element 21.

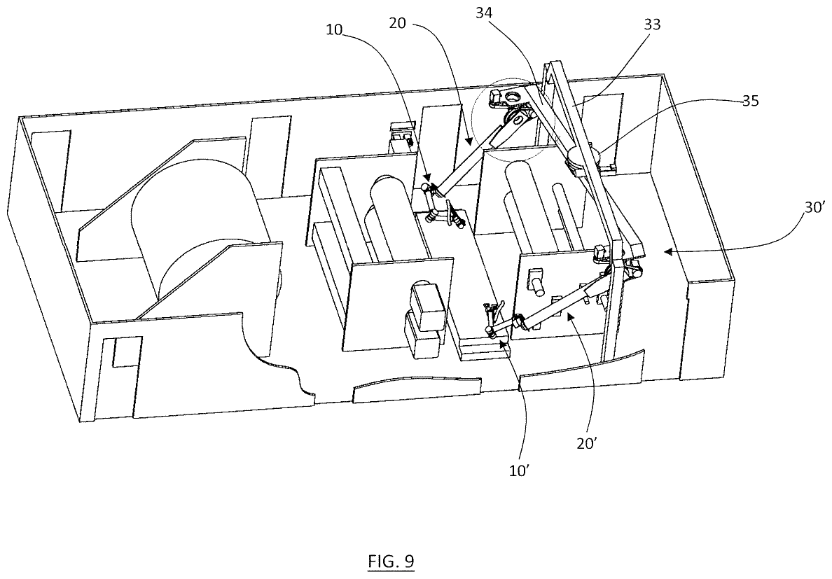

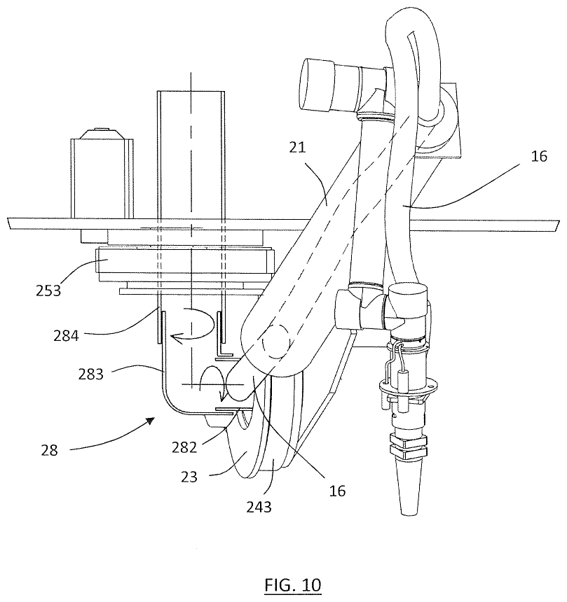

With reference to FIG. 10, the suction mouth is connected to the pipe 16 which passes through the elongated tubular element 21 and is connected by means of the fulcrum assembly 28 with vacuum creating members, constituted for example by a pump and a system for filtering powders, not shown and not further described as of known art. More specifically, the flexible pipe 16 internally crosses the elongated tubular element 21 from one end to the other by inserting it into a tubular portion 282, integral with the driven wheel 243. The tubular portion 282 is inserted into an “L” pipe, 283, so as to be free to rotate while maintaining the air tightness. Likewise, the “L” pipe 283 is inserted with the possibility of rotation and air tightness in a fixed intake pipe 284, which passes through the second driven wheel 253 thus allowing the passage of air without losses through said fulcrum assembly (28). This construction advantageously makes it possible to simplify the air path, makes it more efficient and, since it does not need pipes which, as a result of the positioning of the elongated element, must be folded and adapted to the different geometries, is particularly robust and economical. In this way, a fulcrum assembly 28 is provided, comprising oscillating joints-assemblies, which are controlled for positioning the elongated tubular element 21 which supports the robotic arm 10, where the air path starting from a fixed pipeline, preferably placed in the air and therefore above all the plants, it reaches the same robotic arm 10 with the shortest path, with a single curve and above all simplifying the suction system due to the absence of flexible pipes that would have had inefficiencies for the bending breaks on the curves, beyond for requesting other support devices such as chain-holders or the like which entail additional dimensions and costs.

It should also be noted that the robotic arm 10 and the oscillation assembly 20 are two components of the device of the present invention which are functionally and structurally very different from each other. In fact, a robotic arm, whether it has three controlled axes as in the described example or with several controlled axes, is commonly known to be an extremely versatile programmable device that allows to quickly and accurately position and orient objects in space and to obtain such results, however, need a robust structure. Moreover, the elongated elements 11 and 12 of the robotic arm 10 have a contained length, that is to say the sum of the lengths of the related elongated elements should not be greater than 1.5 meters, to increase the ability to move in small spaces. Moreover, each controlled axis, with the relative motor, adds weight to the structure of the robotic arm 10. Otherwise, the elongated tubular element 21 which carries the robotic arm has a much longer length, approximately equal to the height of the implant machines, so that the oscillation assembly 20 is advantageously anchored above the machinery and the elongated tubular element 21 can however be moved so that the robotic arm 10 can operate close to the ground. The elongated tubular element 21 has a structure which must be load-bearing and rigid and at the same time must be hollow to allow the piping systems to pass inside.

In a variant embodiment of the invention, the elongated tubular elements 21 are advantageously two, where the first works on the horizontal plane, allowing the upper zones of the implants to be reached from a raised position, and a second elongated tubular element allowing the robotic arm 10 to reach even areas near the floor and then bring the joint close to the areas to be cleaned.

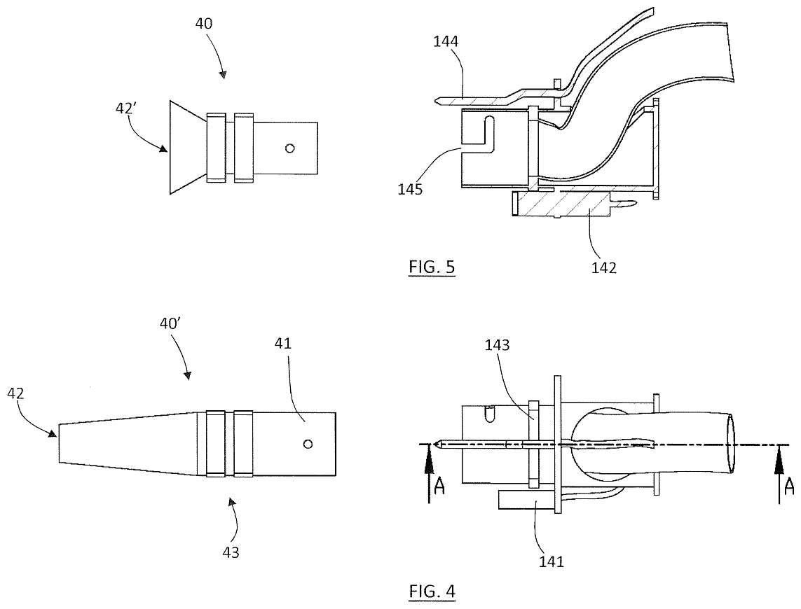

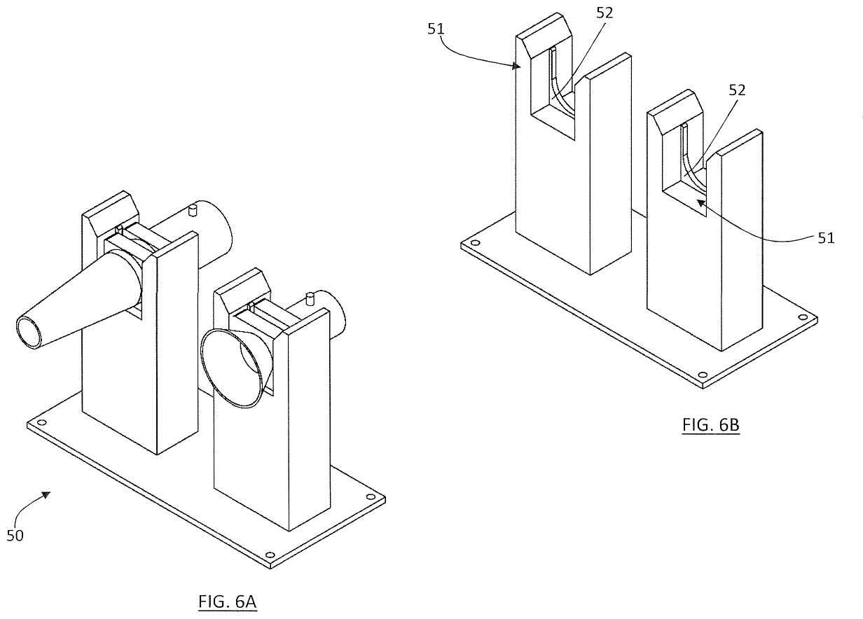

As better visible in FIGS. 4 and 5, at the end of the manifold 15 it is removably mounted a suction mouth 40, 40′, which provides connecting means 41 to the manifold 14, an intake opening, 42, and retaining means, 43, consisting of an intermediate zone with a square outer shape with an annular groove. The connecting means 41 comprise a protruding pin, 411, from the outer cylindrical portion, which is inserted in a respective slot, 145, in the shape of an “L” of the manifold 14 which has at its end a slightly conical shape. To the manifold 15 are also associated a vision sensor, 141, a temperature sensor, 142, a force sensor, 143, for the purpose of acquiring images and data on the temperature of the materials of the machine, of detecting a thrust load. In addition, a vacuum level measuring sensor is installed in the suction line (not shown) in order to signal any eventual value increase. The signal and power cables of the above sensors 141, 142, 143 are flanked by the flexible pipe 16 along the articulations of the robotic arm 10 to reach a control processor which controls the apparatus 1.

At the working head 14 there is also associated at least a first compressed air blow nozzle, connected to compressed air pipes running along said robotic arm 10 and said elongated tubular element 21. The nozzle for blowing compressed air is arranged to blow compressed air through the suction mouth 40 (not shown because internal). At least one further nozzle for compressed air blowing 144, which receives compressed air from the same compressed air lines of the first nozzle, is associated with the working head 14 for blowing air towards the surfaces to be cleaned, i.e. substantially in the direction identified by the suction mouth 40.

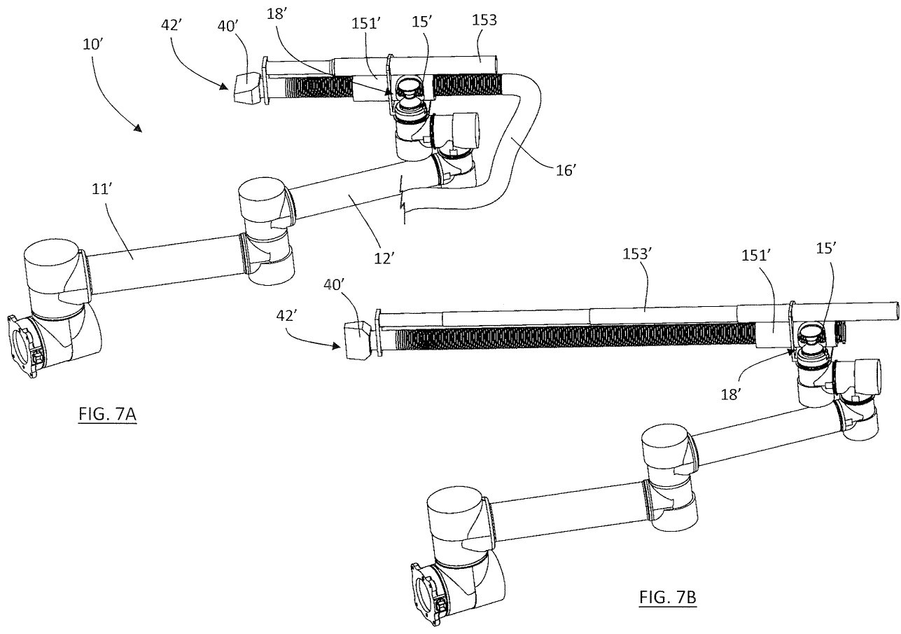

With reference to FIG. 7, an advantageous embodiment of an apparatus according to the present invention provides a robotic arm 10′ with three rotational joints, and two elongated elements, 11′, 12′. A working head, 14′, disposed at the free end of the robotic arm 10′ comprises means adapted to move the suction mouth away and towards with respect to the end of the robotic arm 10′. Specifically, in the embodiment shown, the aforesaid means comprise a rotating pulley, 18′, which operates by contact on a manifold, 15′. The pulley 18′ takes the rotary motion from the last actuated axis of the robotic arm 10′. The manifold 15′ is a tubular element which can slide inside a sleeve, 151′, connected to the non-rotating part of the end of the robotic arm. From the manifold 15′ there is a flexible pipe, 16′, connected in some points to the elongated elements 11′, 12′ of the robotic arm 10 so that it can accept the various positions assumed by the arm itself. In the exemplary embodiment shown, the pipeline is connected in a sliding manner to the same points of the elongated elements 11 and 12. The manifold 15′ is dragged by friction from the pulley, preferably made of rubber material, but it could also be a toothed pulley and the manifold could have in that case a rack. The manifold 15′ has a key slot and the sleeve 151′ has a key along its whole length to constrain not to rotate the manifold itself, allowing it only to translate. A linear encoder is also installed between the key element of the manifold and the sleeve so as to be able to send the signals to the processor and to perfectly control the position of a suction mouth 40′ mounted at the end of the sleeve 15′ with respect to the robotic arm 10′.

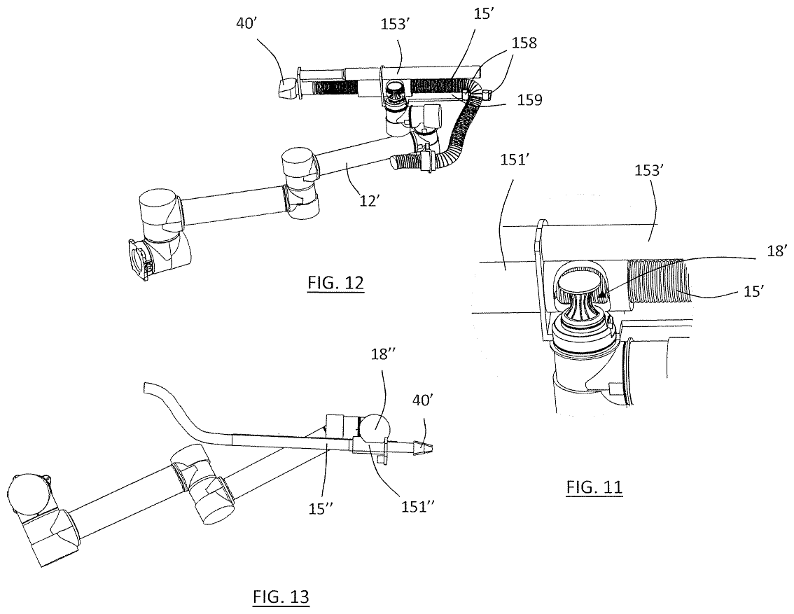

In the embodiment shown, the manifold 15′ has a cylindrical shape and is flexible of corrugated type and in this example is dragged to advance by the rubberized pulley 18′, as shown in detail in FIG. 11, and maintained in a straight configuration by a telescopic tube, 153′, connected to the sleeve 151′, which also in this case has a function of containment and guide to the flexible manifold. Advantageously, the flexible manifold portion 15′ which is located upstream of the sleeve 151′ can be kept close to the robotic arm 10′ to reduce the overall dimensions. This last variant embodiment is shown in FIG. 12, in which is visible a constraint element 159, integral with the support of the rubberized pulley 18′, which has two return rollers 158, freely rotatable around its axis, through which runs the flexible manifold 15′ in order to be deviated with respect to the direction of displacement along which it is guided by the telescopic tube 153′. Thanks to the presence of the constraint element 159, when the pulley 18′ rotates in the direction useful to retract the mouth 40′ by approaching it, the portion of the flexible manifold 15′ which moves away from the pulley 18′ from the opposite side is deflected in correspondence of the return rollers 158 towards the elongated element 12′ preventing it from creating an obstacle posterior to the elongation direction of the suction mouth 40′. In this way the variations in the length of the manifold 15′ can be absorbed leaving the manifold 15′ free to make loops, widen and spread, in an area upstream of the robotic arm 10 where there is no need for reduced overall dimensions. In a further embodiment, the telescopic tube 153′ is a linear cylinder actuated, advantageously by compressed air, and therefore has the function of thrusting element of the suction mouth 40′ to reduce the force of the pulley 18′ and therefore of the head of the robotic arm 10 to turn away the suction mouth 40′.

Despite the above-described embodiment being particularly advantageous, further solutions may be provided for turning away and close the suction mouth, 40, 40′ from the end of the robotic arm on which it is mounted. In FIG. 13 there is shown a further variant embodiment which still provides the presence of a toothed pulley, 18″, actuated in rotation which transmits the motion to a rigid manifold 15″ through a rack which is integral with it. The rack, passing inside the sleeve 151″ provided with a suitable through groove also has the function of preventing the rotation of the manifold 15″ with respect to the sleeve 151″.

In the variant embodiments of Figs. from 7 to 13 the suction mouth 40′ is connected to the end of the sleeve 15′, 15″ with a snap joint or a threaded one. The suction mouth 40′ is advantageously provided with brushes (not shown) in correspondence of the related suction opening 42′.

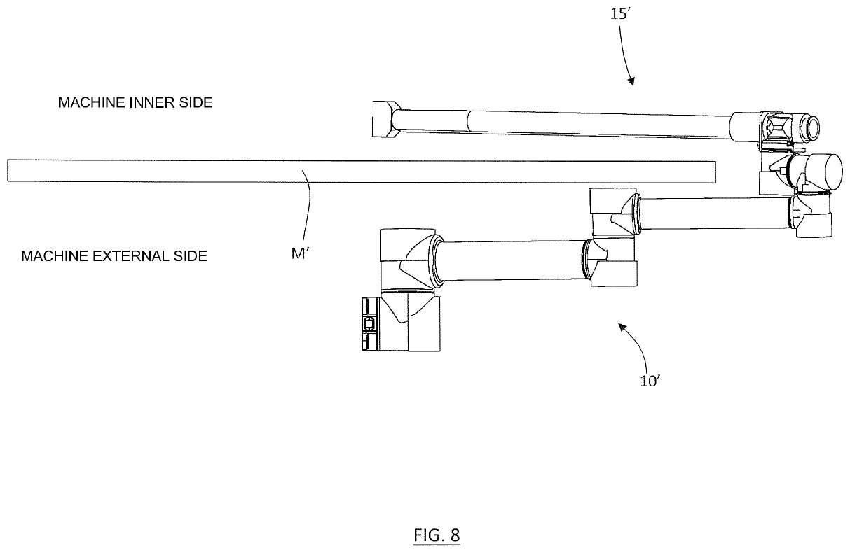

The embodiments of Figs. from 7 to 13 are particularly advantageous since the extendable manifold 15′, 15″ allows to reach positions difficult to access even in the event that the robotic arm 10′ is anchored to a fixed support. With reference to FIG. 8, such an applicative solution is shown in which the robotic arm 10′ is fixedly mounted outside a wall, Ml, of a machine, and is able to reach areas of the relative machine which are immediately behind to the aforesaid wall Ml, which can be reached only thanks to the presence of the extensible manifold 15′.

A preferred operation mode of an apparatus according to the present invention is described below.

An operator enters the safety zone of the Line L after having deactivated all the energy sources and uses the suction robotic arm 10. First, he activates the suction system and starts the cleaning work by moving the mouth manually by means of a relative handle (not shown). That is, he follows all the surfaces of the machinery of the L line making sure to remove the dust through mechanical removal from the contact with the brushes and the suction action. At the same time he inserts the movements acquisition confirmations in the control panel of a control unit of the apparatus which then performs a first self-learning phase called for example work area “x”. For the cleaning of the floor or walkways he chooses to use the second type of suction mouth 40′ which is more performing for the flat surfaces. Therefore, by means of the relative handle, he moves the robotic arm 10 to the storage station 50 by inserting it into the corresponding seat 51 so that it is connected and performs the movements of rotation and extraction of the manifold 14. Then, he inserts the manifold 14 into the other suction mouth 40′ and performs the hooking operations, pulls it out sideways, activates the suction and starts the movements to perform the cleaning. After the footplates and the floor are clean as well, he replaces the suction mouth 40′ in the relative seat 51 of the storage station 50, moves the oscillation assembly 20 by means of a handle (not shown) so that the robotic arm 10 can reach a new working area called “y”, confirms the self-learning data and uses the sucking robotic arm 10 starting from the connection of a suction port 40. Similarly to what was done for zone “x”, he cleans the “y” zone and confirms the self-learning data at the control panel. According to a preferred embodiment, the movement of the robotic arm 10 is programmed so that the suction mouth 40 is brought to an opening 60, which is present on the protections P so that it is accessible from the outside. After the machines S, G, R and the floorings S are cleaned, he leaves the safe area and activates the machines themselves and the production. At this point the operator may decide to set the cleaning operation of the “x” area with a frequency of each hour from the control panel, alternating with the cleaning operation of the “y” area. The vision sensor 141 located at the end of the robotic arm 10 allows the operator to follow the cleaning steps and to understand if it is necessary to make successive corrections to the pre-set movement.

According to an alternative embodiment of the method of the invention, the movement of the robotic arm 10′ is programmed so that the suction mouth 40′ is brought to an opening, 60, present on the protections P so that it is accessible from the outside. This way an operator can verify the integrity and/or replace the mouth manually. The above variant embodiment is particularly suitable for being implemented with the embodiment of FIG. 7 of the apparatus of the invention.

According to a further alternative embodiment, the method of the invention envisages acquiring the shape of the machine and reconstructing the cleaning mapping to be performed by means of software (3D scanner). This way even the self-learning phase is completely automatic.

The force sensor 143, on the other hand, allows the robotic arm 10 to be preserved from collisions if the surface to be cleaned has been modified without having updated the program movements. In this case the robotic arm 10 could stop and give an alarm signal. The temperature sensor 142 performs a control function when it is used to move around parts which tend to overheat as electric motors or bearings. In this case, a system prevention function is carried out, since it can signal any temperature values outside the set interval. The air vacuum sensor detects value increases that signal the occlusion of the suction mouth 40 and activate a puff of compressed air through the suction mouth 40. After this operation, if the vacuum value remains high, the robotic arm positions the mouth on the opening 60 outside the protections P, in the accessible area awaiting a manual intervention for cleaning the suction mouth 40. The positioning of the robotic arm 10 in an area accessible to the operator is also useful for cleaning or replacing the sensors 141, 142, 143 also during the production process.

The oscillation assembly 20 makes it possible to position the robotic arm 10 at different areas in correspondence of which the robotic arm 10 operates in a determined useful working volume within which the relative movement is programmed for self-learning as above described. It also allows to position the entire oscillating arm and the relative robotic arm in a position remote from the machine, for example completely vertical to allow ordinary maintenance without creating any encumbrance. Once the work in that particular useful working volume has been completed, the oscillation assembly 20 is programmed to move the robotic arm 10 until it is brought in correspondence with a useful working volume adjacent to it, or in any case distinguished from the previous one.

The moving members of the robotic arm 10, that is to say the oscillation assembly 20, are particularly suitable for the application described in which it is necessary to clean the line L. The oscillation assemblies are extremely simple and therefore they have very reduced costs.

Obviously, moving members 20, 30 of the robotic arm 10 can be provided and more suitable, for example in case of a different configuration of the volumes to be cleaned. For example, in an alternative embodiment, a robotic arm 10 of the present invention is mounted on board of a shuttle capable of moving in the plant to reach certain precise points where electrical power, compressed air and suction connections are installed. In this way a single robotic arm 10 is able to perform the cleaning of many areas, being able to use different points at different times.

With reference to FIG. 9, an advantageous variant embodiment of an apparatus according to the present invention provides for the presence of a second crosspiece 34, arranged aligned with the crosspiece 33 immediately below it and supported by the crosspiece 33 in rotary mode with respect to a vertical axis by means of a rotational support assembly 35, arranged in a substantially central zone of the two cross-members 33 and 34. In this embodiment, it is the second cross member 34 that is associated with the oscillation assemblies 20 and 20′ near its own ends.

The presence of the second cross member 34 rotatable with respect to the crosspiece 33 allows the robotic arms 10 and 10′ to reach much greater distances so that the portal 30′ can be anchored in a fixed position with respect to the cables and pipes for power supply and air transport can reach the robotic arms 10 and 10′ simply due to their flexibility without having to resort to translating cable chains. All this brings clear advantages from the point of view of reducing production costs.

According to a further alternative embodiment of the invention, the crosspiece 33 or the group consisting of the crosspiece 33 and the second crosspiece 34, instead of being associated with the mobile portal 30, constitute a fixed support structure. This last variant embodiment is particularly useful where, due to the small size of the plants to be cleaned, the operating spaces of the apparatus can be contained with the advantage of a reduction in construction costs.

The apparatus of the present invention can clean an industrial plant from dust without the need for machine stops, increasing production efficiency. The powders can be removed before accumulations are created, which affects the process and especially in the process of converting the paper where the tape can be interrupted due to the falling of paper dust lumps between rotating parts and fixed parts. Furthermore, the powders can be removed before they accumulate between the electronic and mechanical organs creating faults or premature wear. Operators who access the internal areas do not risk slipping, for example in the case of the footboards and the steps that, covered with dust, lose the effectiveness of their anti-slip surfaces. Furthermore, operators do not have health safety problems because they are prevented from breathing dust in manual cleaning operations. In fact, powders do not accumulate on the air surfaces of machines such as beams and structures, preventing them from falling onto the product, especially when the product is toilet paper or towel, creating problems of contamination and poor quality.

The robotic arm 10 carries with it inside and outside the machinery which cleans vision and temperature sensors 142 for controlling the members of the machine so as to prevent possible failures.

Finally, the power required for generating the volume of suction air for the present invention is much less, a ratio of one to ten is estimated, with respect to the current solutions adopted.

The characteristics and advantages outlined above of a cleaning apparatus according to the present invention are particularly evident when the applied is applied to a line for converting the paper, however they remain substantially safeguarded even in different applications, such as cleaning of machinery that perform machining operations for the removal of shavings, for example for woodworking or in general in machinery or industrial lines in which there is production of powders or other small scraps that can be vacuumed. In all these types of systems, the apparatus of the invention can effectively replace the conventional suction systems with the above advantages.

Finally, the aforementioned advantages remain safeguarded even in the presence of variations or modifications of practical application that can be made by a technician in the field to a cleaning apparatus as described above, while remaining within the protection zone defined by the following claims.

1.-23. (canceled)

24. An apparatus for cleaning industrial plants of the type, comprising:
suction members operable for sucking powders and working fragments within a working volume in which an industrial processing plant is installed; and
an anthropomorphic robotic arm with at least three controlled axes provided with a working head comprising a manifold on which a suction mouth is installed, connected through the manifold and a duct suction to vacuum creating organs;
wherein the robotic arm is controlled by a control unit through self-learning, the working head comprising means operable for moving the suction mouth away from and close to an end of the robotic arm.

25. The apparatus for cleaning industrial plants according to claim 24, wherein the working head comprises a rotating pulley that takes the motion from the last actuation of the robotic arm and operates by contacting a manifold that can slide within a dinghy connected to the non-rotating part of the end of the robotic arm, so that the manifold is driven by the pulley.

26. The apparatus for cleaning industrial plants according to claim 25, wherein the manifold is flexible and of the corrugated type and is maintained in a straight configuration by a telescopic tube connected to the dinghy.

27. The apparatus for cleaning industrial plants according to claim 26, wherein the telescopic tube is a linear cylinder actuated by compressed air operable to constitute a thrust element of the suction mouth to reduce the stress exerted by the pulley and therefore of the head of the robotic arm to remove the suction mouth.

28. The apparatus for cleaning industrial plants according to claim 27, further comprising a constraint element integral with the support of the rubberized pulley, which has return rollers freely rotatable around its axis, through which the flexible manifold flows to be deviated with respect to the direction of displacement along which it is guided by the telescopic tube so that as the pulley rotates in the direction useful for retracting the suction mouth bringing it closer to itself, the portion of the flexible manifold that moves away from the pulley from the opposite side is deflected by the return rollers towards the elongated element preventing it from creating an obstruction posterior to the elongation direction of the suction mouth.

29. The apparatus for cleaning industrial plants according to claim 24, further comprising movable members for programmable movements operable to move the robotic arm in correspondence of useful volumes of different works.

30. The apparatus for cleaning industrial plants according to claim 29, wherein the programmable movement members comprise at least one oscillation assembly for the robotic arm, the oscillation assembly comprising at least one elongated tubular element supporting at one end of the robotic arm, and a fulcrum assembly integral with the other end of the elongated tubular element.

31. The apparatus for cleaning industrial plants according to claim 30, wherein the suction mouth is connected to a flexible pipe that passes through the elongated tubular element and through the fulcrum assembly is connected with vacuum-creating members.

32. The apparatus for cleaning industrial plants according to claim 31, wherein the flexible pipe internally passes from one end to the other the elongated tubular element by inserting itself into a tubular portion integral with a driven wheel of the fulcrum assembly, the tubular portion inserting into an “L” pipe so as to be free to rotate while maintaining the air tightness, the “L” pipe inserting as well with possibility of rotation and air tightness in a fixed suction duct that crosses a second driven wheel orthogonal to the first driven wheel, thus allowing the leak-free air passage through the fulcrum assembly.

33. The apparatus for cleaning industrial plants according to claim 30, further comprising a portal on which the oscillation assembly is mounted, the portal being operable for moving the oscillation assembly along the line of industrial machinery.

34. The apparatus for cleaning industrial plants according to claim 30, wherein the fulcrum assembly is associated with a crosspiece and arranged to rotate the elongated tubular element with respect to at least a vertical axis and a horizontal axis.

35. The apparatus for cleaning industrial plants according to claim 34, wherein the crosspiece is included in the portal.

36. The apparatus for cleaning industrial plants according to claim 34, wherein the crosspiece constitutes a fixed support structure.

37. The apparatus for cleaning industrial plants according to claim 34, wherein the suction mouth is removably associated with the manifold, the apparatus comprising a storage station of the suction mouths provided with housing seats for the suction mouths, so that by means of movements of the robotic arm the suction mouth associated with the manifold is deposited in a respective housing of the storage station and replaced with a different suction mouth present in the storage station.

38. The apparatus for cleaning industrial plants according to claim 34, further comprising a crosspiece and a second crosspiece that in the proximity of its own end is associated with the oscillation assembly, the second crosspiece being supported by the crosspiece in rotary mode with respect to a vertical axis by means of a rotational support assembly.

39. The apparatus for cleaning industrial plants according to claim 38, wherein the crosspiece constitutes a fixed support structure.

40. The apparatus for cleaning industrial plants according to claim 38, wherein the portal comprises a crosspiece and a second crosspiece which, in the proximity of its ends, is associated with the oscillation assembly, the second crosspiece being supported in a central area by the crosspiece in rotary mode with respect to a vertical axis by means of a rotational support assembly.

41. The apparatus for cleaning industrial plants according to claim 33, wherein the portal is provided with a motor and respective transmission means for moving the portal longitudinally along the line and the fulcrum assembly is provided with first and second rotation means arranged to transmit the rotary motion with respect to two rotation axes orthogonal to each other to the oscillation assembly, the control unit of the apparatus being programmable to control the actuation of the gate movement motor and of the first and second rotation means so as to move the robotic arm in correspondence with useful volumes of different jobs such to coves the entire volume to be cleaned.

42. The apparatus for cleaning industrial plants according to claim 24, wherein the vacuum conduit is associated a vacuum level sensor.

43. The apparatus for cleaning industrial plants according to claim 24, wherein the working head is associated with a viewing sensor.

44. The apparatus for cleaning industrial plants according to claim 24, wherein the working head is associated with a temperature sensor.

45. The apparatus for cleaning industrial plants according to claim 24, wherein the working head is associated with a force sensor.

46. The apparatus for cleaning industrial plants according to claim 24, wherein the working head is associated with a compressed air blowing nozzle operable for blowing compressed air towards the surfaces to be cleaned.
